(19) United States
(12) Patent Application Publication
(10) Pub. No.: US 2023/0195243 A1
(43) Pub. Date: Jun. 22, 2023

(54) DIRECTIONAL INPUT DEVICE FOR COMPUTER MOUSE

(71) Applicant: Microsoft Technology Licensing, LLC, Redmond, WA (US)

(72) Inventors: James McColl SHIELDS, Seattle, WA (US); Ryan Eugene WHITAKER, Seattle, WA (US)

(21) Appl. No.: 17/556,251

(22) Filed: Dec. 20, 2021

(51) Int. Cl. G06F 3/0354; G06F 3/0346

(52) U.S. Cl. CPC G06F 3/03543; G06F 3/0346

(57) ABSTRACT

A computer mouse includes a body and a multi-directional input device. The body has a top surface and a side surface. The top surface is configured to contact a user's palm and fingers, and the side surface is configured to contact a user's thumb. The multi-directional input device positioned on the side surface, and the multi-directional input device receives directional inputs from the user's thumb.

### BACKGROUND

### Background and Relevant Art

Electronic device controllers allow users to quickly provide directional inputs to a video game console or other computing device. Joysticks, thumbsticks, directional pads, and other input devices can allow for analog or digital inputs with an electronic device controller. The directional input sticks or pads move within a range of motion relative to an input device body, providing myriad input possibilities. Tactile feedback and/or precision can have a large effect on the performance of the input device, and preferences regarding a shape, mass, dimension, or texture of the directional input device can be specific to different users.

### BRIEF SUMMARY

In some embodiments, a computer mouse includes a body and a multi-directional input device. The body has a top surface and a side surface. The top surface is configured to contact a user's palm and fingers, and the side surface is configured to contact a user's thumb. The multi-directional input device positioned on the side surface, and the multi-directional input device receives directional inputs from the user's thumb.

In some embodiments, a computer mouse includes a body, an aperture in the body, and a multi-directional input device positioned at least partially through the aperture. The body has a top surface and a side surface. The top surface is configured to contact a user's palm and fingers, and the side surface is configured to contact a user's thumb aperture. The aperture is in the side surface of the body. The multi-directional input device is configured to receive directional inputs from the user's thumb. The multi-directional input device includes a thumbstick with a tiltable axis tiltable relative to the body and a sensor to measure an analog position of the thumbstick relative to the body.

In some embodiments, a method of receiving user inputs includes obtaining a position of a multi-directional input device on a side surface of a computer mouse at a computing device and, subsequently, obtaining a position input from the multi-directional input device based at least partially upon the position of the multi-directional input device measured.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1-1 is a top view of a computer mouse;

FIG. 1-2 is a side view of the computer mouse of FIG. 1-1;

FIG. 2 is a side view of a computer mouse with a multi-directional input device, according to at least one embodiment of the present disclosure;

FIG. 3-1 is a side view of moving a multi-directional input device, according to at least one embodiment of the present disclosure;

FIG. 3-2 is a side view of the computer mouse of FIG. 3-1 providing a confirmation with the multi-directional input device, according to at least one embodiment of the present disclosure;

FIG. 4-1 is a side view of a computer mouse with a clickable multi-directional input device, according to at least one embodiment of the present disclosure;

FIG. 4-2 is a side view of the computer mouse of FIG. 4-1 with the multi-directional input device depressed, according to at least one embodiment of the present disclosure;

FIG. 5-1 is an illustration of selecting an input based at least partially on moving a head of a multi-directional input device, according to at least one embodiment of the present disclosure;

FIG. 5-2 is an illustration of selecting a second input with the multi-directional input device by providing a shift command, according to at least one embodiment of the present disclosure;

FIG. 6 is a side view of a multi-directional input device with a plurality of peaks, according to at least one embodiment of the present disclosure;

FIG. 7 is an illustration of a plurality of aperture shapes, according to at least one embodiment of the present disclosure;

FIG. 8 is an illustration of a multi-directional input device with a translatable axis, according to at least one embodiment of the present disclosure;

FIG. 9-1 is a side view of a computer mouse with a multi-directional input device including a directional pad according to at least one embodiment of the present disclosure;

FIG. 9-2 is a side view of the computer mouse of FIG. 9-1 with the directional pad translated relative to the body of the computer mouse, according to at least one embodiment of the present disclosure;

FIG. 10 is a schematic representation of a visual display corresponding to inputs from a multi-directional input device, according to at least one embodiment of the present disclosure; and

FIG. 11 is a flowchart illustrating a method receiving user inputs with a computer mouse including a multi-directional input device, according to at least one embodiment of the present disclosure.

### DETAILED DESCRIPTION

The present disclosure relates generally to systems and methods for providing user inputs to an electronic device. More particularly, the input devices described herein are configured to allow directional inputs to a computing device or a specialized video game console. In some embodiments, an input device according to the present disclosure is an electronic device controller that may be in data communication with an electronic device, such as a personal computer or video game console. In some embodiments, a computer mouse is in data communication with a personal computer or video game console via a wired data connection. In other embodiments, the computer mouse is in wireless data communication with a personal computer or video game console.

A mouse is conventionally used to provide movement inputs to a personal computer or video game console to move a cursor and/or change a camera angle in a computer game. For example, a mouse is conventionally used to move a cursor relative to a user interface in an operating system or various software applications. In some embodiments, the software application is a game application.

The game application may assign the mouse movements to other control functionality during gameplay, such as in a game application that uses a first-person perspective. In a first-person perspective, a game application may assign the mouse movements, such as movements in the x-direction and the y-direction to move the camera perspective in a horizontal and vertical rotational direction.

In some examples, the game application uses a third-person perspective. In such games, the mouse may be used to move the camera depicting the player character and/or the game environment, while the mouse movement is also used to move a cursor to select objects in the user interface and/or game environment. Additionally, some game applications provide the user with a large number of abilities or items available for use at any time. Conventionally, some abilities are bound to certain keys to provide shortcuts in the user interface to reduce dependency on moving a selection cursor within the user interface to use the abilities. However, this can result in dozens of abilities being bound to keyboard of a personal computer or video game console, while the computer mouse is associated with cursor movement and/or camera controls with two or three buttons on the mouse.

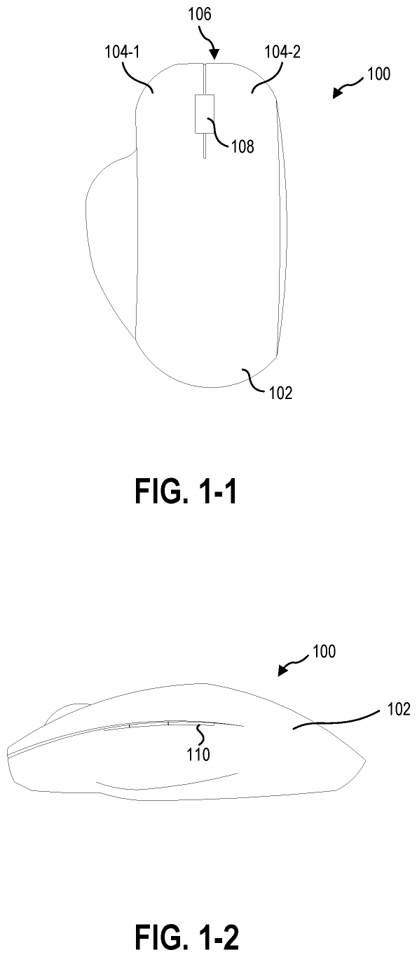

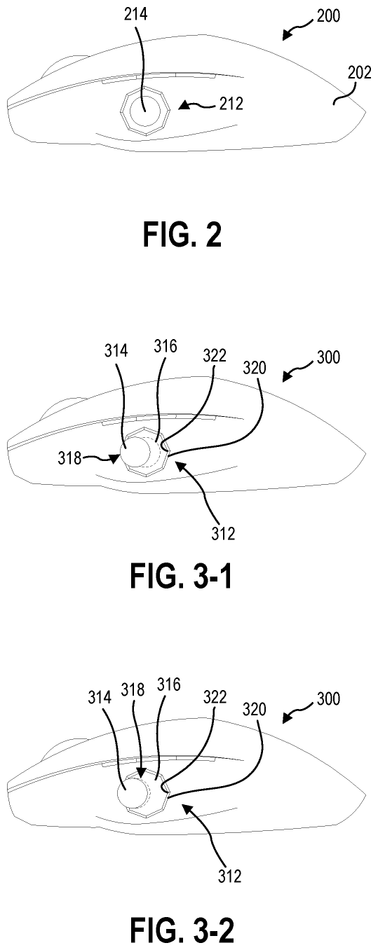

Referring now to FIG. 1, a conventional computer mouse 100 includes a body 102 configured to contact a user's palm with a pair of mouse buttons 104 (left mouse button 104-1 and right mouse button 104-2) positioned at a forward end 106 of the body 102 to contact and receive inputs from the user's index and middle finger. In some examples, a scroll wheel 108 is provided, and some users operate the scroll wheel 108 with a middle finger while operating the right mouse button 104-2 with the fourth finger (i.e., ring finger). Referring now to FIG. 1-2, some examples of a conventional mouse 100 include thumb buttons 110 on a side of the body 102, which are conventionally used for browser navigation but may be rebound. In most game applications, the thumb buttons 110 are not used.

Even if rebound to other functions, in complex software applications, the thumb buttons 110 on the side of the mouse 100 do not provide enough input options and/or lack directionality, which limits the usefulness of the thumb buttons 110. FIG. 2 is a side view of another embodiment of a computer mouse 200. In some embodiments according to the present disclosure, a computer mouse 200 includes a multi-directional input device 212 on a side surface of the mouse 200 to receive inputs from the user's thumb while controlling the mouse 200. The multi-directional input device 212 may allow the user to provide directional inputs (e.g., up, down, left, right) and/or provide a plurality of different input commands by moving the multi-directional input device 212 relative to a body 202 of the mouse 200.

In some embodiments, the multi-directional input device 212 includes a potentiometer or other sensor that allows the measurement of position of a head 214 of the multi-directional input device 212 relative to the body 202. For example, the multi-directional input device 212 may be an analog thumbstick. The position of a head 214 of the thumbstick is measured and periodically reported to the personal computer or video game console by the mouse 200. In some embodiments, an analog thumbstick allows for precise directional inputs with a range of input magnitudes. For example, an analog thumbstick may allow the user to control a camera perspective in a multiplayer online battle arena (MOBA) game application, camera position in a real-time strategy (RTS) game application, or other directional controls in a software application. In other examples, the analog thumbstick allows a gradient of input magnitudes with an associated directional component that allows for control of an avatar from a slow walk through a full run in the virtual environment.

Referring now to FIGS. 3-1 and 3-2, in some embodiments, the multi-directional input device 312 includes a digital switch button, similar to a button on a conventional gamepad controller, that registers a contact and reports the button input. For example, the body of the mouse includes an aperture 316 through which the head 314 and post 318 supporting the head 314 of the multi-directional input device 312 are positioned. Because thumbstick movement of the side of a mouse 300 is a new experience, users may lack precision with their control of the multi-directional input device 312 movement.

In some embodiments, the aperture 316 provides tactile feedback or information on the position of the head 314 and post 318 of the multi-directional input device 312. For example, the user can move the tilt or move the head 314 of the multi-directional input device 312 toward a forward position of the multi-directional input device 312 relative to the aperture 316. In some embodiments, the aperture 316 is a circle that provides a smooth and continuous perimeter against which the multi-directional input device 312 can move. In some embodiments, such as depicted in FIG. 3-1, the aperture 316 includes one or more facets 320 that contact a post 318 of the multi-directional input device 312. The post 318 can move toward the edge of the aperture 316 and contact the facet 320 before being received in a corner 322 between two facets 320.

The faceted aperture 316, thereby, provides tactile feedback to the user through the movement of the head 314 connected to the post 318 when the post 318 contacts the edge of the aperture 316. The facets 320 guide the multi-directional input device 312 to the corners 322 between the facets 320. The facets 320 can thereby provide the user with orientation as the user moves the head 314 during gameplay or other usage when the user is unable to visually confirm the position of the multi-directional input device 312 relative to the body 302. In some embodiments, the corners 322 can be positioned at cardinal directions for directional inputs with the multi-directional input device 312. For example, the corners 322 can be positioned to provide tactile references for the x-axis and y-axis of the multi-directional input device 312. Depending on the game application, the corners 322 can provide references for forward, back, up, down, left, right, etc. In some embodiments, such as a faceted aperture 316 including eight facets 320, diagonal directions have corners 322, as well, allowing for reference positions for diagonal inputs, as well.

In some embodiments, each corner 322 is associated with a different digital button input. While directional inputs (e.g., forward, back, up, down, left, right) have been described herein, a set of digital input buttons may be associated with various locations proximate the edges of the aperture 316. In some embodiments, a switch or pressure sensor is positioned proximate at least one corner 322 and/or at cardinal direction (top, bottom, left, right). For example, the digital switch, button, or pressure sensor at one or more locations around the edge of the aperture 316 can receive force from the post 318 and/or the head 314 of the multi-directional input device 312 when the user presses the head 314 and/or post 318 toward the edge of the aperture 316. In some embodiments, a switch or pressure sensor is positioned to be actuated when the head 314 is pushed against at least one corner 322 and/or at cardinal direction (top, bottom, left, right). For example, the switch may be positioned opposite a corner 322 such that a lower portion of the post 318 (e.g., inside the body 302 of the mouse 300) contacts the switch when the head 314 is moved to tilt the post 318 relative to the aperture 316.

A digital switch, button, or pressure sensor at one or more locations around the edge of the aperture 316 allows the user to press the head 314 of the multi-directional input device 312 toward one or more locations proximate the edge of the aperture 316 to provide various inputs to the mouse 300 and the computer system to which the mouse 300 is connected. In some embodiments, the eight corners 322 described herein each correspond to an arrow key or combination of arrow key inputs such as the computer or game console's keyboard. In some embodiments, the eight corners 322 correspond to a number pad input, such as 1 through 8 or 0 through 7. In some embodiments, the eight corners 322 correspond to keyboard inputs, such as conventional WASD directional inputs. By corresponding the multi-directional input device 312 inputs to keyboard bindings, the user inputs transmitted by the multi-directional input device 312 may be transparent to the system, as the multi-directional input device 312 transmits known inputs to the computer, game console, or game application.

In some embodiments, the user inputs received by the multi-directional input device 312 are communicated to a software interface at the computer, game console, or game application that interprets the inputs as specific commands for the game application. As will be described in more detail herein, the software add-on or module may interpret the inputs from the multi-directional input device 312 for use in the game application. In the example of a MMORPG, the use may have available to them dozens of abilities, spells, useable items, or commands at any given time. In some embodiments, at least some of the abilities, spells, usable items, or commands are bound to numbers on the keyboard, and the inputs of the multi-directional input device 312 can provide number inputs that activate the associated ability, spell, usable item, or command irrespective of the source of the number input, and thereby, the input from the multi-directional input device 312 is transparent to the game application. In other embodiments, an add-on or software module may interpret the input from the multi-directional input device 312 as a unique user input in addition to the number inputs of the number keys of the keyboard. For example, an in-game avatar of the user may be movable in the virtual environment by directional inputs (either digital or analog) provided through the multi-directional input device 312, which then leaves the conventional directional inputs of the keyboard (e.g., WASD, arrow keys, number pad, etc.) available to control other abilities, spells, usable items, or commands. In some examples, the user may choose to use the WASD keys to control movement within the environment, the camera perspective using conventional mouse movements (such as through an optical sensor), and abilities, spells, usable items, or commands with the different digital inputs of the switches, pressure sensors, or buttons of the multi-directional input device 312.

In some embodiments, the multi-directional input device 312 may allow for both analog inputs and digital inputs. For example, a potentiometer may measure the relative position of the head 314 and/or post 318 of the multi-directional input device 312 relative to the body 302 and the multi-directional input device 312 may include one or more switches, sensors, or buttons proximate the edge of the aperture 316 to measure button inputs. In some embodiments, the multi-directional input device 312 includes or requires a confirmation to limit accidental inputs. For example, the user may accidentally move the head 314 of the multi-directional input device 312 while gripping the mouse 300 and moving the mouse 300 to input conventional mouse movement inputs. To limit accidental or false inputs, the multi-directional input device 312 may not transmit or report an input until a confirmation is received.

In some embodiments, the confirmation is a “click-through” confirmation, such as illustrated in FIG. 3-2. When the head 314 and/or post 318 is moved to an edge of the aperture 316, the aperture 316, facets 320, corners 322, etc. may contact the head 314 and/or post 318 to provide tactile feedback to the user of the position of the head 314 and/or post 318. The confirmation of the input may be provided by applying additional force to push through a detent of multi-directional input device 312 and move the head 314 a final confirmation movement, as illustrated in FIG. 3-2. The confirmation movement provides a second tactile feedback in addition to the initial resistance of locating the multi-directional input device 312 in one of the input positions. In at least one embodiment, the resistance that is overcome by the confirmation movement is provided by the button, switch, or pressure sensor described herein.

In other embodiments, the confirmation is provided by another button or input. For example, the user may move the multi-directional input device 312 to a forward position, such as illustrated in FIG. 3-2, and the confirmation is provided by clicking the scroll wheel. In other examples, the confirmation is provided by another input device different from the mouse 300, such as a spacebar on a keyboard.

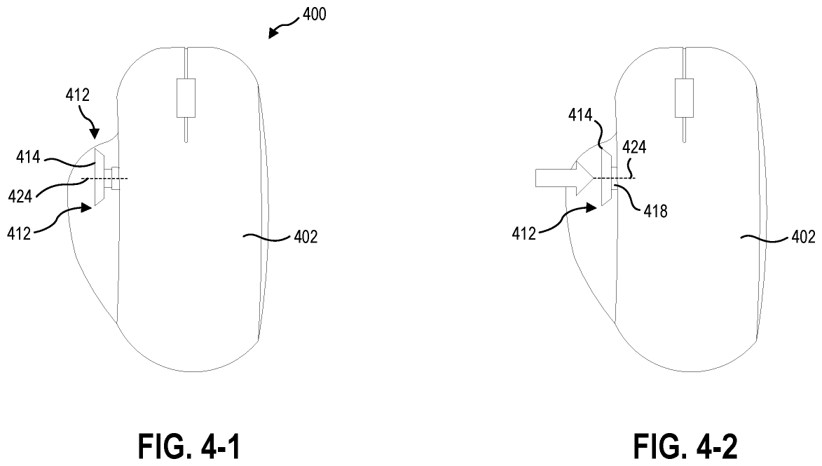

In at least one embodiment, the head 314 of the multi-directional input device 312 is movable in a z-direction to “click” the multi-directional input device 312. For example, FIG. 4-1 is a top view of another embodiment of a mouse 400 with a multi-directional input device 412. The head 414 is moveable in a z-direction of the multi-directional input device 412. The multi-directional input device 412 has a tiltable axis 424 that is tilted by movement of the head 414 and post 418 relative to the body 402 of the mouse 400. The z-direction is the axial direction of the tiltable axis 424, meaning the multi-directional input device 412 is clickable by the user pressing the head 414 toward the body 402 of the mouse, as illustrated in FIG. 4-2.

In some embodiments, depressing the head 414 toward the body 402 and/or in the z-direction provides a confirmation for the directional inputs. For example, in such an embodiment, clicking the multi-directional input device 412 or moving the multi-directional input device 412 relative to the aperture, as described in relation to FIGS. 3-1 and 3-2, individually will not provide any input to the mouse 400. Only clicking the multi-directional input device 412 while the head 414 is moved to, for example, a corner of the aperture (such as the corners 322 described in relation to FIGS. 3-1 and 3-2) will confirm and transmit an input.

In other embodiments, depressing the head 414 toward the body 402 and/or in the z-direction provides another input that is separate from the directional inputs. For example, clicking the multi-directional input device 412 can provide an additional input for the game application to interpret or provide an input that can be bound to any expected keyboard input. For example, a user may find it desirable to bind a “reload” command to clicking the multi-directional input device 412 while keyboard inputs are used for movement and traversal, the mouse movements aim a reticle, and the directional inputs of the multi-directional input device 412 select from a radial menu of weapons.

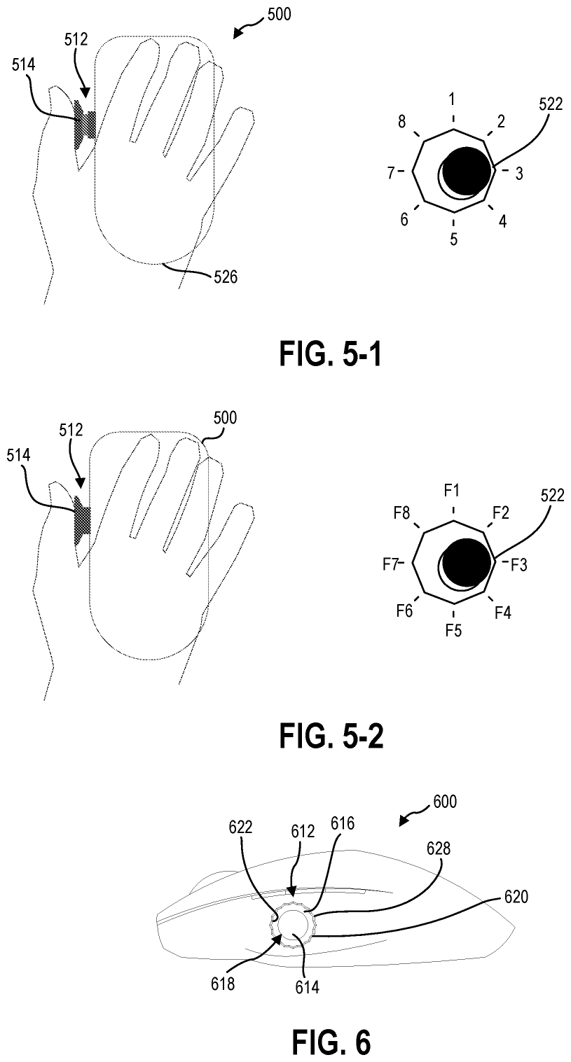

In yet other embodiments, depressing the multi-directional input device 412 is one mechanism to provide a “shift” command that changes the interpretation of the directional inputs of the multi-directional input device 412. FIGS. 5-1 and 5-2 is an example of directional inputs received by an embodiment of a mouse 500 where depressing the multi-directional input device 512 in the z-direction changes the interpretation of position 3 (e.g., a corner 522 of the multi-directional input device 512 proximate a rear end 526 of the body of the mouse 500) from “command 3” in FIG. 5-1 to “command F3” FIG. 5-2.

For example, the position 3 input illustrated in FIG. 5-1 may correspond to a particular healing spell for the user's in-game avatar in a game application like Elder Scrolls Online. The shift command input by the user by depressing the multi-directional input device 512, illustrated in FIG. 5-2, changes the state of the position 3 input to a position F3 input, which may correspond to a consumable healing item for the user's in-game avatar in Elder Scrolls Online. This may allow the user to quickly select healing via a spellcasting ability or healing via consuming an item in their inventory using the same movement of the head 514 (e.g., toward the same corner 522) of the multi-directional input device 512 and simply choosing between the two input commands through the selective depression of the head 514 of the multi-directional input device 512. In at least one embodiment, the click-through confirmation, such as described in relation to FIG. 3-2 is used with the shift command described in relation to FIG. 5-1 and FIG. 5-2, allowing the user to move the head 514 toward the corner 522, then depress the head 514 to input the shift command, and subsequently click-through the resistance of the switch or detent to confirm the position F3 input.

The tactile feedback and/or quantity of corners on the multi-directional input device can be further increased by creating recesses at the corners that resist angular movement to capture the post when engaged with the recess. FIG. 6 is a side view of another embodiment of a mouse 600 according to the present disclosure. The mouse 600 includes a multi-directional input device 612 with a plurality of facets 620 around the perimeter of the aperture 616. In some embodiments, the facets 620 form corners 622 in the edge of the aperture 616 with peaks 628 angularly between the corners 622. Unlike other embodiments described herein, the facets 620 that form peaks 628 force the head 614 and/or post 618 of the multi-directional input device 612 to move radially toward the center of the aperture in order for the head 614 and/or post 618 to move in an angular (i.e., rotational direction) around the edge of the aperture 616. The corners 622 between the peaks 628 are, therefore, more angularly stable than corners without peaks between, such as those described in relation to FIG. 3-1. The user can position the head 614 and/or post 618 of the multi-directional input device 612 in the corner 622 between the peaks 628 to stage the input before confirming the input with a confirmation with less concern that the multi-directional input device 612 will change position.

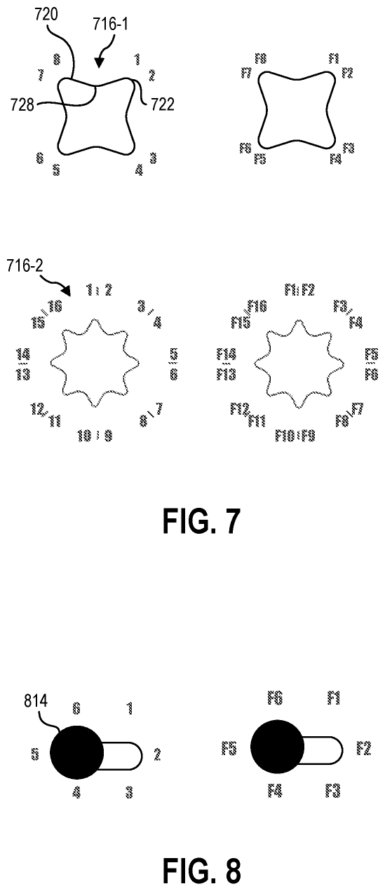

In some embodiments, the tactile feedback provided by the facets or other shape of the aperture allows the user to position the multi-directional input device proximate to more than one potential input. FIG. 7 illustrates a plurality of aperture shapes. In some embodiments, the shape of the aperture 716-1, 716-2 includes corners 722 with peaks 728 therebetween. In some embodiments, the corners 722 and/or the peaks 728 are defined by facets of the aperture shape. In other embodiments, the corners 722 and/or the peaks 728 are defined by one or more curved surfaces. The corners 722, however, are configured to receive the head and/or post of the multi-directional input device and capture the head and/or post to limit the angular movement of the head and/or post and stage the multi-directional input device adjacent to switches, buttons, pressure sensors, or other input surfaces on the aperture edge.

In some embodiments, at least one corner 722 of the aperture 716-1, 716-2 is proximate to a plurality of switches, buttons, pressure sensors, or other input surfaces on the aperture edge. For example, each lateral side of the corner 722 may have one or more switches, buttons, pressure sensors, or other input surfaces on the aperture edge. The user may, therefore, position the head and/or post proximate to, or even contacting, a plurality of switches, buttons, pressure sensors, or other input surfaces and click-through the detent of one of the switches, buttons, pressure sensors, or other input surfaces to confirm that input quickly.

In a particular example, a corner may include switches, buttons, pressure sensors, or other input surfaces for input position 1 and input position 2, and the user may stage position the head and/or post in the corner for quick selection or rapid sequences of each input. In another example, the shift command described in relation to FIGS. 5-1 and 5-2 may further allow the two input positions to also support an input position F1 and F2. FIG. 7 illustrates a four-corner aperture 716-1 and an eight-corner aperture 716-2 that may be used in a multi-directional input device, where each corner includes a plurality of switches, buttons, pressure sensors, or other input surfaces according to the present disclosure.

In at least one embodiment, the tiltable axis of the head and post of the multi-directional input device is, itself, translatable relative to the aperture. FIG. 8 is an example of a translatable head and post of a multi-directional input device. In some embodiments, the axis of the head and post translates relative to the aperture and/or the body the mouse, allowing for the same tilt of the head 814 (such as tilting the head up) to select a plurality of different input positions. In the illustrated embodiment, tilting the head 814 upward can select either the input position 1 or the input position 6, depending on the translational position of the head 814 and tiltable axis. In some embodiments, a shift command can further allow another set of selectable input positions, such as an upward tilt selecting either the F1 input position or the F6 input position, depending on the translational position of the head 814 and tiltable axis.

In at least one embodiment, the translation of the axis of the head and/or post is a shift command for the multi-directional input device. FIGS. 9-1 and 9-2 illustrate another embodiment of a mouse 900 with a multi-directional input device 912. In some embodiments, directional input devices allow a user to indicate a direction an on-screen cursor or avatar should move relative to an environment. In some instances, an analog or digital thumbstick is appropriate to provide directional inputs to move an avatar in a relation to a three-dimensional virtual environment. For example, the analog thumbstick allows a gradient of input magnitudes with an associated directional component that allows for control of an avatar from a slow walk through a full run in the virtual environment.

In other instances, a cross-shaped directional input pad is appropriate to provide discrete directional control. For example, an analog input device can be unpredictable for a user in a menu selection screen with discrete options. Inputs from the analog input device may produce no movement of a cursor between the discrete options until a threshold of the analog input device is met, at which point the cursor may move unexpectedly, producing imprecise control for the user. In other examples, some applications and video games interpret series of discrete directional inputs as special commands that evoke unique techniques of the user's avatar or unlock additional features of the application or video game. In at least one example, a fighting video game interprets a precise series of directional inputs as a special command to attack using a projectile attack. In other examples, a particular series of directional inputs provided by a user at a menu screen unlocks additional options or resources.

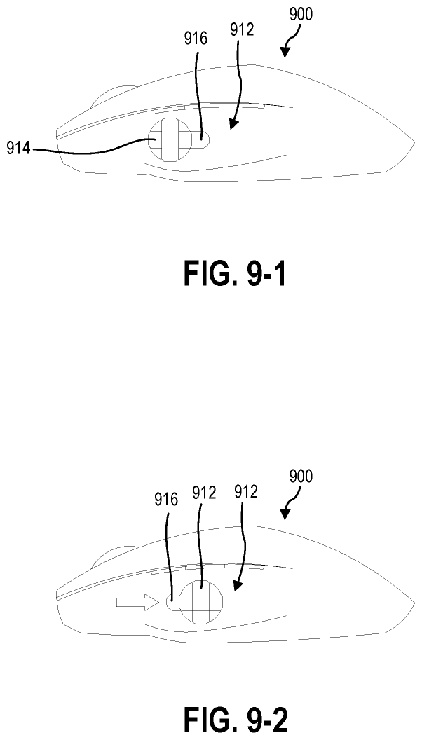

The head 914 illustrated in FIG. 9-1 is a directional input pad that allows for 4 or 8 discrete directional inputs. When the head 914 is located in the forward position in the aperture 916, the head 914 allows the user access to input positions 1 through 8, while translating the head 914 to a rearward position in the aperture 916 illustrated in FIG. 9-2 allows the user access to input positions F1 through F8.

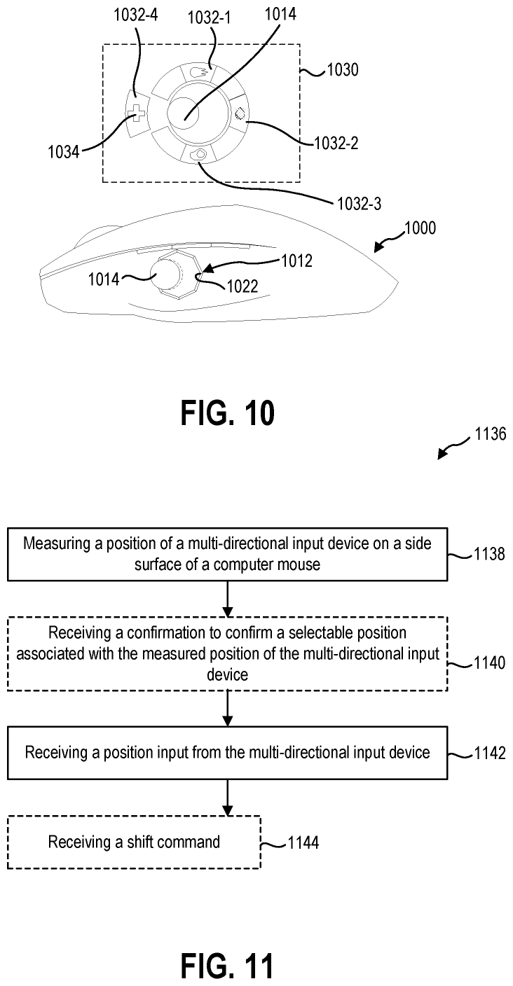

In some embodiments, the inputs from the multi-directional input device are interpreted by a game application or other software application that provides a visual display to the user on a display (a computer monitor, television, integrated display in the computing device, etc.). FIG. 10 illustrates an embodiment of a visual display 1030 to convey a measured state of the multi-directional input device 1012 to a user. The visual display 1030 includes a plurality of selectable actions 1032-1, 1032-2, 1032-3, 1032-4 in a game application that correspond to the position of the head 1014 of the multi-directional input device 1012.

In some embodiments, the visual display 1030 includes a real-time representation of a measured position of the head 1014. In some embodiments, the visual display 1030 displays a selected action (such as the fourth selectable action 1032-4 in FIG. 10) based on the head 1014 measured in a corresponding position, such as a corner 1022 of the multi-directional input device 1012. The selectable actions 1032-1, 1032-2, 1032-3, 1032-4 can, in some examples, display generic labels or representations of the input, such as numeral characters for each position of the head 1014. In other examples, the labels or symbols on the visual display 1030 are user-selectable to reflect frequently used commands by the user. In yet other examples, the labels 1034 or symbols of the 1032-1, 1032-2, 1032-3, 1032-4 on the visual display 1030 are provided by the game application and reflect the labels, symbols, or icons used in the game application user interface.

For example, in a game application with spellcasting, the labels 1034 of the selectable positions 1032-1, 1032-2, 1032-3, 1032-4 include representation for a fireball spell, a water spell, an earth spell, and a healing spell, respectively. The healing spell is currently selected by positioning the head 1014 of the multi-directional input device 1012 in the associated corner 1022. The visual display 1030 provides feedback to the user that the healing spell (e.g., the fourth selectable position 1032-4) is selected by moving, highlighting, animating, or otherwise altering the label 1034. In some embodiments, the visual display 1030 provides feedback of the currently selected position before a confirmation is received so that the user knows what selectable position 1032-1, 1032-2, 1032-3, 1032-4 will be selected when a confirmation input is provided. In the illustrated embodiment, the visual display 1030 indicates the healing spell is selected, and the user provides a confirmation input by clicking through a detent to confirm the selection of the healing spell.

In some embodiments, the orientation of the multi-directional input device relative to the selectable positions 1032-1, 1032-2, 1032-3, 1032-4 and/or the visual display 1030 is adjustable. For example, FIG. 10 illustrates a set of selectable positions 1032-1, 1032-2, 1032-3, 1032-4 that corresponds to side view of the computer mouse 1000. In some embodiments, a user may find the orientation of the selectable positions 1032-1, 1032-2, 1032-3, 1032-4 to be more intuitive when the “forward position” of the multi-directional input device 1012 is mapped or bound to the first (i.e., “up”) selectable position 1032-1 as moving the computer mouse 1000 away from the user is conventionally associated with moving a cursor or reticle up on user interface displayed on the display device.

Referring now to FIG. 11, in some embodiments, a method 1136 of receiving user inputs with a mouse according to the present disclosure includes measuring a position of a multi-directional input device on a side surface of a computer mouse (e.g., any computer mouse described in relation to FIG. 1 through FIG. 10) at 1138. In some embodiments, measuring a position of the multi-directional input device includes measuring the position with a potentiometer or other sensor to measure an analog position. In some embodiments, measuring a position of the multi-directional input device includes measuring the position with a digital contact switch, button, pressure sensor, or other device that provides a digital position (on or off) of the multi-directional input device.

In some embodiments, the method 1136 optionally further includes receiving a confirmation to confirm a selectable position associated with the measured position of the multi-directional input device at 1140. In some embodiments, the confirmation is received from the multi-directional input device of the mouse. For example, the confirmation may be a click-through a detent in the head movement of the multi-directional input device. In other examples, the confirmation is a z-direction movement of the head and/or post of the multi-directional input device. In some embodiments, the confirmation is received from another input device of the mouse, such as mouse button or scroll wheel. In some embodiments, the confirmation is received from a keyboard. In some embodiments, the confirmation is received from the mouse.

The method further includes receiving a position input from the multi-directional input device at 1142. In some embodiments, the position input is based at least partially upon the measured position of the multi-directional input device. In some embodiments, the position input is based at least partially upon the measured position of the multi-directional input device when the confirmation is received. In some embodiments, the position input is based at least partially upon a shift state of the multi-directional input device. For example, a shift command is optionally received at 1144, which selects a position input from a plurality of positions inputs based on the measured position of the multi-directional input device. In at least one example, the measured position is “up” and no shift command is received, so a first position input is received, while in another example, the measured position is “up” and a shift command is received, so a second position input is received (e.g., position input 1 and position input F1 of FIG. 5-1 and FIG. 5-2). In some embodiments, the method 1136 further includes displaying a selectable position and/or an associate command in a game application to a user with a visual display, such as that described in relation to FIG. 10.

In at least one embodiment according to the present disclosure, a computer mouse includes a multi-directional input device on a side surface thereof, and the multi-directional input device allows a user to provide directional user inputs to the computer mouse and/or computing device connected thereto.

### INDUSTRIAL APPLICABILITY

The present disclosure relates generally to systems and methods for providing user inputs to an electronic device. More particularly, the input devices described herein are configured to allow directional inputs to a computing device or a specialized video game console. In some embodiments, an input device according to the present disclosure is an electronic device controller that may be in data communication with an electronic device, such as a personal computer or video game console. In some embodiments, a computer mouse is in data communication with a personal computer or video game console via a wired data connection. In other embodiments, the computer mouse is in wireless data communication with a personal computer or video game console.

A mouse is conventionally used to provide movement inputs to a personal computer or video game console to move a cursor and/or change a camera angle in a computer game. For example, a mouse is conventionally used to move a cursor relative to a user interface in an operating system or various software applications. In some embodiments, the software application is a game application.

The game application may assign the mouse movements to other control functionality during gameplay, such as in a game application that uses a first-person perspective. In a first-person perspective, a game application may assign the mouse movements, such as movements in the x-direction and the y-direction to move the camera perspective in a horizontal and vertical rotational direction.

In some examples, the game application uses a third-person perspective. In such games, the mouse may be used to move the camera depicting the player character and/or the game environment, while the mouse movement is also used to move a cursor to select objects in the user interface and/or game environment. Additionally, some game applications provide the user with a large number of abilities or items available for use at any time. Conventionally, some abilities are bound to certain keys to provide shortcuts in the user interface to reduce dependency on moving a selection cursor within the user interface to use the abilities. However, this can result in dozens of abilities being bound to keyboard of a personal computer or video game console, while the computer mouse is associated with cursor movement and/or camera controls with two or three buttons on the mouse.

In some embodiments according to the present disclosure, a computer mouse includes a multi-directional input device on a side surface of the mouse to receive inputs from the user's thumb while controlling the mouse. The multi-directional input device may allow the user to provide directional inputs (e.g., up, down, left, right) and/or provide a plurality of different input commands by moving the multi-directional input device relative to a body of the mouse.

In some embodiments, the multi-directional input device includes a potentiometer or other sensor that allows the measurement of position of a head of the multi-directional input device relative to the body. For example, the multi-directional input device may be an analog thumbstick. The position of a head of the thumbstick is measured and periodically reported to the personal computer or video game console by the mouse. In some embodiments, an analog thumbstick allows for precise directional inputs with a range of input magnitudes. For example, an analog thumbstick may allow the user to control a camera perspective in a multiplayer online battle arena (MOBA) game application, camera position in a real-time strategy (RTS) game application, or other directional controls in a software application. In other examples, the analog thumbstick allows a gradient of input magnitudes with an associated directional component that allows for control of an avatar from a slow walk through a full run in the virtual environment.

In some embodiments, the multi-directional input device includes a digital switch button, similar to a button on a conventional gamepad controller, that registers a contact and reports the button input. For example, the body of the mouse includes an aperture through which the head and post supporting the head of the multi-directional input device are positioned. Because thumbstick movement of the side of a mouse is a new experience, users may lack precision with their control of the multi-directional input device movement.

In some embodiments, the aperture provides tactile feedback or information on the position of the head and post of the multi-directional input device. For example, the user can move the tilt or move the head of the multi-directional input device toward a forward position of the multi-directional input device relative to the aperture. In some embodiments, the aperture is a circle that provides a smooth and continuous perimeter against which the multi-directional input device can move. In some embodiments, the aperture includes one or more facets that contact a post of the multi-directional input device. The post can move toward the edge of the aperture and contact the facet before being received in a corner between two facets.

The faceted aperture, thereby, provides tactile feedback to the user through the movement of the head connected to the post when the post contacts the edge of the aperture. The facets guide the multi-directional input device to the corners between the facets. The facets can thereby provide the user with orientation as the user moves the head during gameplay or other usage when the user is unable to visually confirm the position of the multi-directional input device relative to the body. In some embodiments, the corners can be positioned at cardinal directions for directional inputs with the multi-directional input device. For example, the corners can be positioned to provide tactile references for the x-axis and y-axis of the multi-directional input device. Depending on the game application, the corners can provide references for forward, back, up, down, left, right, etc. In some embodiments, such as a faceted aperture including eight facets, diagonal directions have corners, as well, allowing for reference positions for diagonal inputs, as well.

In some embodiments, each corner is associated with a different digital button input. While directional inputs (e.g., forward, back, up, down, left, right) have been described herein, a set of digital input buttons may be associated with various locations proximate the edges of the aperture. In some embodiments, a switch or pressure sensor is positioned proximate at least one corner and/or at cardinal direction (top, bottom, left, right). For example, the digital switch, button, or pressure sensor at one or more locations around the edge of the aperture can receive force from the post and/or the head of the multi-directional input device when the user presses the head and/or post toward the edge of the aperture. In some embodiments, a switch or pressure sensor is positioned to be actuated when the head is pushed against at least one corner and/or at cardinal direction (top, bottom, left, right). For example, the switch may be positioned opposite a corner such that a lower portion of the post (e.g., inside the body of the mouse) contacts the switch when the head is moved to tilt the post relative to the aperture.

A digital switch, button, or pressure sensor at one or more locations around the edge of the aperture allows the user to press the head of the multi-directional input device toward one or more locations proximate the edge of the aperture to provide various inputs to the mouse and the computer system to which the mouse is connected. In some embodiments, the eight corners described herein each correspond to an arrow key or combination of arrow key inputs such as the computer or game console's keyboard. In some embodiments, the eight corners correspond to a number pad input, such as 1 through 8 or 0 through 7. In some embodiments, the eight corners correspond to keyboard inputs, such as conventional WASD directional inputs. By corresponding the multi-directional input device inputs to keyboard bindings, the user inputs transmitted by the multi-directional input device may be transparent to the system, as the multi-directional input device transmits known inputs to the computer, game console, or game application.

In some embodiments, the user inputs received by the multi-directional input device are communicated to a software interface at the computer, game console, or game application that interprets the inputs as specific commands for the game application. As will be described in more detail herein, the software add-on or module may interpret the inputs from the multi-directional input device for use in the game application. In the example of a MMORPG, the use may have available to them dozens of abilities, spells, useable items, or commands at any given time. In some embodiments, at least some of the abilities, spells, usable items, or commands are bound to numbers on the keyboard, and the inputs of the multi-directional input device can provide number inputs that activate the associated ability, spell, usable item, or command irrespective of the source of the number input, and thereby, the input from the multi-directional input device is transparent to the game application. In other embodiments, an add-on or software module may interpret the input from the multi-directional input device as a unique user input in addition to the number inputs of the number keys of the keyboard. For example, an in-game avatar of the user may be movable in the virtual environment by directional inputs (either digital or analog) provided through the multi-directional input device, which then leaves the conventional directional inputs of the keyboard (e.g., WASD, arrow keys, number pad, etc.) available to control other abilities, spells, usable items, or commands. In some examples, the user may choose to use the WASD keys to control movement within the environment, the camera perspective using conventional mouse movements (such as through an optical sensor), and abilities, spells, usable items, or commands with the different digital inputs of the switches, pressure sensors, or buttons of the multi-directional input device.

In some embodiments, the multi-directional input device may allow for both analog inputs and digital inputs. For example, a potentiometer may measure the relative position of the head and/or post of the multi-directional input device relative to the body and the multi-directional input device may include one or more switches, sensors, or buttons proximate the edge of the aperture to measure button inputs. In some embodiments, the multi-directional input device includes or requires a confirmation to limit accidental inputs. For example, the user may accidentally move the head of the multi-directional input device while gripping the mouse and moving the mouse to input conventional mouse movement inputs. To limit accidental or false inputs, the multi-directional input device may not transmit or report an input until a confirmation is received.

In some embodiments, the confirmation is a “click-through” confirmation. When the head and/or post is moved to an edge of the aperture, the aperture, facets, corners, etc. may contact the head and/or post to provide tactile feedback to the user of the position of the head and/or post. The confirmation of the input may be provided by applying additional force to push through a detent of multi-directional input device and move the head a final confirmation movement. The confirmation movement provides a second tactile feedback in addition to the initial resistance of locating the multi-directional input device in one of the input positions. In at least one embodiment, the resistance that is overcome by the confirmation movement is provided by the button, switch, or pressure sensor described herein.

In other embodiments, the confirmation is provided by another button or input. For example, the user may move the multi-directional input device to a forward position, and the confirmation is provided by clicking the scroll wheel. In other examples, the confirmation is provided by another input device different from the mouse, such as a spacebar on a keyboard.

In at least one embodiment, the head of the multi-directional input device is movable in a z-direction to “click” the multi-directional input device. For example, the head is moveable in a z-direction of the multi-directional input device. The multi-directional input device has a tiltable axis that is tilted by movement of the head and post relative to the body of the mouse. The z-direction is the axial direction of the tiltable axis, meaning the multi-directional input device is clickable by the user pressing the head toward the body of the mouse.

In some embodiments, depressing the head toward the body and/or in the z-direction provides a confirmation for the directional inputs. For example, in such an embodiment, clicking the multi-directional input device or moving the multi-directional input device relative to the aperture individually will not provide any input to the mouse. Only clicking the multi-directional input device while the head is moved to, for example, a corner of the aperture (such as the corners described herein) will confirm and transmit an input.

In other embodiments, depressing the head toward the body and/or in the z-direction provides another input that is separate from the directional inputs. For example, clicking the multi-directional input device can provide an additional input for the game application to interpret or provide an input that can be bound to any expected keyboard input. For example, a user may find it desirable to bind a “reload” command to clicking the multi-directional input device while keyboard inputs are used for movement and traversal, the mouse movements aim a reticle, and the directional inputs of the multi-directional input device select from a radial menu of weapons.

In yet other embodiments, depressing the multi-directional input device is one mechanism to provide a “shift” command that changes the interpretation of the directional inputs of the multi-directional input device. In some examples, depressing the head and/or post of the multi-directional input device in the z-direction changes the interpretation of position 3 (e.g., a corner of the multi-directional input device proximate a rear end of the body of the mouse) from “command 3” to “command F3”.

For example, the position 3 input may correspond to a particular healing spell for the user's in-game avatar in a game application like Elder Scrolls Online. The shift command input by the user by depressing the multi-directional input device changes the state of the position 3 input to a position F3 input, which may correspond to a consumable healing item for the user's in-game avatar in Elder Scrolls Online. This may allow the user to quickly select healing via a spellcasting ability or healing via consuming an item in their inventory using the same movement of the head (e.g., toward the same corner) of the multi-directional input device and simply choosing between the two input commands through the selective depression of the head of the multi-directional input device. In at least one embodiment, the click-through confirmation, such as described herein, is used with the shift command, allowing the user to move the head toward the corner, then depress the head to input the shift command, and subsequently click-through the resistance of the switch or detent to confirm the position F3 input.

The tactile feedback and/or quantity of corners on the multi-directional input device can be further increased by creating recesses at the corners that resist angular movement to capture the post when engaged with the recess. The mouse includes a multi-directional input device with a plurality of facets around the perimeter of the aperture. In some embodiments, the facets form corners in the edge of the aperture with peaks angularly between the corners. Unlike other embodiments described herein, the facets that form peaks force the head and/or post of the multi-directional input device to move radially toward the center of the aperture in order for the head and/or post to move in an angular (i.e., rotational direction) around the edge of the aperture. The corners between the peaks are, therefore, more angularly stable than corners without peaks between. The user can position the head and/or post of the multi-directional input device in the corner between the peaks to stage the input before confirming the input with a confirmation with less concern that the multi-directional input device will change position.

In some embodiments, the tactile feedback provided by the facets or other shape of the aperture allows the user to position the multi-directional input device proximate to more than one potential input. In some embodiments, the shape of the aperture includes corners with peaks therebetween. In some embodiments, the corners and/or the peaks are defined by facets of the aperture shape. In other embodiments, the corners and/or the peaks are defined by one or more curved surfaces. The corners, however, are configured to receive the head and/or post of the multi-directional input device and capture the head and/or post to limit the angular movement of the head and/or post and stage the multi-directional input device adjacent to switches, buttons, pressure sensors, or other input surfaces on the aperture edge.

In some embodiments, at least one corner of the aperture is proximate to a plurality of switches, buttons, pressure sensors, or other input surfaces on the aperture edge. For example, each lateral side of the corner may have one or more switches, buttons, pressure sensors, or other input surfaces on the aperture edge. The user may, therefore, position the head and/or post proximate to, or even contacting, a plurality of switches, buttons, pressure sensors, or other input surfaces and click-through the detent of one of the switches, buttons, pressure sensors, or other input surfaces to confirm that input quickly.

In a particular example, a corner may include switches, buttons, pressure sensors, or other input surfaces for input position 1 and input position 2, and the user may stage position the head and/or post in the corner for quick selection or rapid sequences of each input. In another example, the shift command may further allow the two input positions to also support an input position F1 and F2. In some embodiments, each corner includes and plurality of switches, buttons, pressure sensors, or other input surfaces according to the present disclosure.

In at least one embodiment, the tiltable axis of the head and post of the multi-directional input device is, itself, translatable relative to the aperture. In some embodiments, the axis of the head and post translates relative to the aperture and/or the body the mouse, allowing for the same tilt of the head (such as tilting the head up) to select a plurality of different input positions. In the illustrated embodiment, tilting the head upward can select either the input position 1 or the input position 6, depending on the translational position of the head and tiltable axis. In some embodiments, a shift command can further allow another set of selectable input positions, such as an upward tilt selecting either the F1 input position or the F6 input position, depending on the translational position of the head and tiltable axis.

In at least one embodiment, the translation of the axis of the head and/or post is a shift command for the multi-directional input device. In some embodiments, directional input devices allow a user to indicate a direction an on-screen cursor or avatar should move relative to an environment. In some instances, an analog or digital thumbstick is appropriate to provide directional inputs to move an avatar in a relation to a three-dimensional virtual environment. For example, the analog thumbstick allows a gradient of input magnitudes with an associated directional component that allows for control of an avatar from a slow walk through a full run in the virtual environment.

In other instances, a cross-shaped directional input pad is appropriate to provide discrete directional control. For example, an analog input device can be unpredictable for a user in a menu selection screen with discrete options. Inputs from the analog input device may produce no movement of a cursor between the discrete options until a threshold of the analog input device is met, at which point the cursor may move unexpectedly, producing imprecise control for the user. In other examples, some applications and video games interpret series of discrete directional inputs as special commands that evoke unique techniques of the user's avatar or unlock additional features of the application or video game. In at least one example, a fighting video game interprets a precise series of directional inputs as a special command to attack using a projectile attack. In other examples, a particular series of directional inputs provided by a user at a menu screen unlocks additional options or resources.

The head may be a directional input pad that allows for 4 or 8 discrete directional inputs. When the head is located in the forward position in the aperture, the head allows the user access to input positions 1 through 8, while translating the head to a rearward position in the aperture allows the user access to input positions F1 through F8.

In some embodiments, the inputs from the multi-directional input device are interpreted by a game application or other software application that provides a visual display to the user on a display (a computer monitor, television, integrated display in the computing device, etc.). In some embodiments, a visual display to conveys a measured state of the multi-directional input device to a user. The visual display includes a plurality of selectable actions in a game application that correspond to the position of the head of the multi-directional input device.

In some embodiments, the visual display includes a real-time representation of a measured position of the head. In some embodiments, the visual display displays a selected action (such as the fourth selectable action) based on the head measured in a corresponding position, such as a corner of the multi-directional input device. The selectable actions can, in some examples, display generic labels or representations of the input, such as numeral characters for each position of the head. In other examples, the labels or symbols on the visual display are user-selectable to reflect frequently used commands by the user. In yet other examples, the labels or symbols of the on the visual display are provided by the game application and reflect the labels, symbols, or icons used in the game application user interface.

For example, in a game application with spellcasting, the labels of the selectable positions may include representation for a fireball spell, a water spell, an earth spell, and a healing spell, respectively. The healing spell is currently selected by positioning the head of the multi-directional input device in the associated corner. The visual display provides feedback to the user that the healing spell (e.g., the fourth selectable position) is selected by moving, highlighting, animating, or otherwise altering the label. In some embodiments, the visual display provides feedback of the currently selected position before a confirmation is received so that the user knows what selectable position will be selected when a confirmation input is provided. In the illustrated embodiment, the visual display indicates the healing spell is selected, and the user provides a confirmation input by clicking through a detent to confirm the selection of the healing spell.

In some embodiments, the orientation of the multi-directional input device relative to the selectable positions and/or the visual display is adjustable. In some embodiments, a user may find the orientation of the selectable positions to be more intuitive when the “forward position” of the multi-directional input device is mapped or bound to the first (i.e., “up”) selectable position as moving the computer mouse away from the user is conventionally associated with moving a cursor or reticle up on user interface displayed on the display device.

Referring now to FIG. 11, in some embodiments, a method of receiving user inputs with a mouse according to the present disclosure includes measuring a position of a multi-directional input device on a side surface of a computer mouse (e.g., any computer mouse described herein). In some embodiments, measuring a position of the multi-directional input device includes measuring the position with a potentiometer or other sensor to measure an analog position. In some embodiments, measuring a position of the multi-directional input device includes measuring the position with a digital contact switch, button, pressure sensor, or other device that provides a digital position (on or off) of the multi-directional input device.

In some embodiments, the method optionally further includes receiving a confirmation to confirm a selectable position associated with the measured position of the multi-directional input device. In some embodiments, the confirmation is received from the multi-directional input device of the mouse. For example, the confirmation may be a click-through a detent in the head movement of the multi-directional input device. In other examples, the confirmation is a z-direction movement of the head and/or post of the multi-directional input device. In some embodiments, the confirmation is received from another input device of the mouse, such as mouse button or scroll wheel. In some embodiments, the confirmation is received from a keyboard. In some embodiments, the confirmation is received from the mouse.

The method further includes receiving a position input from the multi-directional input device. In some embodiments, the position input is based at least partially upon the measured position of the multi-directional input device. In some embodiments, the position input is based at least partially upon the measured position of the multi-directional input device when the confirmation is received. In some embodiments, the position input is based at least partially upon a shift state of the multi-directional input device. For example, a shift command is optionally received, which selects a position input from a plurality of positions inputs based on the measured position of the multi-directional input device. In at least one example, the measured position is “up” and no shift command is received, so a first position input is received, while in another example, the measured position is “up” and a shift command is received, so a second position input is received (e.g., position input 1 and position input F1). In some embodiments, the method further includes displaying a selectable position and/or an associate command in a game application to a user with a visual display.

In at least one embodiment according to the present disclosure, a computer mouse includes a multi-directional input device on a side surface thereof, and the multi-directional input device allows a user to provide directional user inputs to the computer mouse and/or computing device connected thereto.

The present disclosure relates to systems and methods for providing inputs to an electronic device according to at least the examples provided in the sections below:

[A1] In some embodiments, a computer mouse includes a body and a multi-directional input device. The body has a top surface and a side surface. The top surface is configured to contact a user's palm and fingers, and the side surface is configured to contact a user's thumb. The multi-directional input device positioned on the side surface, and the multi-directional input device receives directional inputs from the user's thumb.

[A2] In some embodiments, the multi-directional input device of [A1] is a thumbstick.

[A3] In some embodiments, the multi-directional input device of [A1] is a directional input pad.

[A4] In some embodiments, the multi-directional input device of any of [A1] through [A3] includes an analog sensor to measure a tilt position of a head of the multi-directional input device relative to the body.

[A5] In some embodiments, the multi-directional input device of any of [A1] through [A3] includes a digital contact switch configured to engage when a head of the multi-directional input device.

[A6] In some embodiments, the multi-directional input device of any of [A1] through [A5] is positioned in an aperture of the body, and the aperture includes a plurality of facets that provide discrete corners for a post of the multi-directional input device.

[A7] In some embodiments, the plurality of facets of [A6] define peaks in the aperture between which the post can be received and, when positioned in the corner between the peaks, the post resists angular movement.

[A8] In some embodiments, the multi-directional input device of any of [A1] through [A7] is movable in a z-direction normal to a top surface of a head of the multi-directional input device.

[A9] In some embodiments, moving the multi-directional input device of [A8] in the z-direction provides a shift command.

[A10] In some embodiments, moving the multi-directional input device of [A8] in the z-direction provides a confirmation.

[A11] In some embodiments, the multi-directional input device of any of [A1] through [A10] has a tiltable axis and a pivot point of the tiltable axis, and the pivot point is translatable relative to the body.

[A12] In some embodiments, translating the pivot point and tiltable axis of [A11] provides a shift command.

[B1] In some embodiments, a computer mouse includes a body, an aperture in the body, and a multi-directional input device positioned at least partially through the aperture. The body has a top surface and a side surface. The top surface is configured to contact a user's palm and fingers, and the side surface is configured to contact a user's thumb aperture. The aperture is in the side surface of the body. The multi-directional input device is configured to receive directional inputs from the user's thumb. The multi-directional input device includes a thumbstick with a tiltable axis tiltable relative to the body and a sensor to measure an analog position of the thumbstick relative to the body.

[B2] In some embodiments, the computer mouse of [B1] includes a detent to resist tilting movement of the thumbstick. The multi-directional input device provides a confirmation after a user tilts the thumbstick past the detent.

[C1] In some embodiments, a method of receiving user inputs includes obtaining a position of a multi-directional input device on a side surface of a computer mouse at a computing device and, subsequently, obtaining a position input from the multi-directional input device based at least partially upon the position of the multi-directional input device measured.

[C2] In some embodiments, the method of [C1] includes receiving a confirmation to confirm a selectable position associated with the position of the multi-directional input device measured.

[C3] In some embodiments, the confirmation of [C2] is received from the computer mouse.

[C4] In some embodiments, the confirmation of [C2] is received from the multi-directional input device.

[C5] In some embodiments, the method of any of [C1] through [C4] includes receiving a shift command, wherein the shift command alters the position input.

[C6] In some embodiments, the method of any of [C1] through [C5] includes displaying the position of the multi-directional input device measured on a visual display on a display device.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A computer mouse, the mouse comprising:
a body with a top surface and a side surface, wherein the top surface is configured to contact a user's palm and fingers and the side surface is configured to contact a user's thumb; and
a multi-directional input device positioned on the side surface and configured to receive directional inputs from the user's thumb, wherein the multi-directional input device has a tiltable axis and a pivot point of the tiltable axis, the pivot point being translatable relative to the body.

2. The mouse of claim 1, wherein the multi-directional input device is a thumb stick.

3. The mouse of claim 1, wherein the multi-directional input device is a directional input pad.

4. The mouse of claim 1, wherein the multi-directional input device includes an analog sensor to measure a tilt position of a head of the multi-directional input device relative to the body.

5. The mouse of claim 1, wherein the multi-directional input device includes a digital contact switch configured to engage when a post of the multi-directional input device contacts the digital contact switch.

6. The mouse of claim 1, wherein the multi-directional input device is positioned in an aperture of the body, wherein the aperture includes a plurality of facets that provide discrete corners for a post of the multi-directional input device.

7. The mouse of claim 6, wherein the plurality of facets define peaks in the aperture between which the post can be received and, when positioned in the corner between the peaks, the post resists angular movement.

8. The mouse of claim 1, wherein the multi-directional input device is movable in a z-direction normal to a top surface of a head of the multi-directional input device.

9. The mouse of claim 8, wherein moving the multi-directional input device in the z-direction provides a shift command.

10. The mouse of claim 8, wherein moving the multi-directional input device in the z-direction provides a confirmation.

11. The mouse of claim 1, wherein the multi-directional input device includes an analog sensor to measure a tilt position of a head of the multi-directional input device relative to the body and a switch configured to engage when a post of the multi-directional input device contacts the digital contact switch.

12. The mouse of claim 1, wherein translating the pivot point and tiltable axis provides a shift command.

13. A computer mouse, the mouse comprising:
a body with a top surface and a side surface, wherein the top surface is configured to contact a user's palm and fingers and the side surface is configured to contact a user's thumb;
an aperture in the side surface; and
a multi-directional input device positioned at least partially through the aperture in the side surface and configured to receive directional inputs from the user's thumb, the multi-directional input device including:
a thumb stick with a tiltable axis relative to the body and a pivot point of the tiltable axis, the pivot point being translatable relative to the body, and
a sensor to measure an analog position of the thumbstick relative to the body.

14. The computer mouse of claim 13, further comprising a detent to resist tilting movement of the thumbstick, wherein the multi-directional input device provides a confirmation after a user tilts the thumbstick past the detent.

15. A method of receiving user inputs comprising:
at a computing device:
receiving a position of a multi-directional input device on a side surface of a computer mouse including a tilt position relative to tiltable axis and a translational position of a pivot point of the tiltable axis relative to side surface of the computer mouse, and
receiving a position input from the multi-directional input device based at least partially upon the position of the multi-directional input device measured.

16. The method of claim 15, further comprising receiving a confirmation to confirm a selectable position associated with the position of the multi-directional input device measured.

17. The method of claim 16, wherein the confirmation is received from the computer mouse.

18. The method of claim 16, wherein the confirmation is received from the multi-directional input device.

19. The method of claim 15, further comprising receiving a shift command, wherein the shift command alters the position input.

20. The method of claim 15, further comprising displaying the position of the multi-directional input device measured on a visual display on a display device.
